(19) United States
(12) Patent Application Publication
(10) Pub. No.: US 2026/0203912 A1
(43) Pub. Date: Jul. 16, 2026

(54) DRIVING ASSISTANCE DEVICE, DRIVING ASSISTANCE METHOD, AND RECORDING MEDIUM

(71) Applicant: NEC Corporation, Minato-ku, Tokyo (JP)

(72) Inventor: Tatsuo ABE, Tokyo (JP)

(73) Assignee: NEC Corporation, Minato-ku, Tokyo (JP)

(21) Appl. No.: 19/127,845

(22) PCT Filed: Nov. 21, 2022
(86) PCT No.: PCT/JP2022/042951

§ 371 Date: May 7, 2025

(51) Int. Cl. G06T 7/20; B60W 50/14; G06V 20/56; G06V 40/10; G06V 40/16

(52) U.S. Cl. CPC G06T 7/20; B60W 50/14; G06V 20/588; G06V 40/103; G06V 40/175

(57) ABSTRACT

A driving assistance device according to an aspect of the present disclosure includes: at least one memory storing instructions; and at least one processor configured to execute the instructions to: acquire an image obtained by imaging a crosswalk in a travel direction from a host vehicle; detect a pedestrian present within a predetermined distance from the crosswalk, based on the image; acquire a change in a motion vector of the pedestrian and a facial state of the pedestrian; estimate a motion of the pedestrian with respect to the crosswalk, based on the change in the motion vector and the facial state; and output information regarding the motion of the pedestrian based on an estimation result.

### TECHNICAL FIELD

The present disclosure relates to a driving assistance device, a driving assistance system, a driving assistance method, and a recording medium.

### BACKGROUND ART

To achieve traffic accidents, it is urgent to enhance advanced driver-assistance system (ADAS) functions. Stopping when a pedestrian is about to traverse a crosswalk is regulated by the law. In many cases, however, the stopping depends on the driver's judgment and is sometimes overlooked. Thus, the stopping is not always performed.

For the above reason, there is a technique for notifying a driver of information on a pedestrian near a crosswalk. For example, PTL 1 describes a technique for estimating a moving body state regarding traversing a road, for example, such as traversing, waiting for traversing, or near a crosswalk based on a position of a bottom side of a bounding box surrounding an object, such as a detected person or bicycle.

### CITATION LIST

### Patent Literature

PTL 1: JP 2022-027306 A

### SUMMARY OF INVENTION

### Technical Problem

It may, however, be difficult to determine how a pedestrian will move near a crosswalk, based on a location of the pedestrian.

An object of the present disclosure is to provide a driving assistance device, for example, that can effectively alert a presence of a pedestrian near a crosswalk.

### Solution to Problem

A driving assistance device according to an aspect of the present disclosure includes image acquisition means for acquiring an image obtained by imaging a crosswalk in a travel direction from a host vehicle, pedestrian detection means for detecting a pedestrian present within a predetermined distance from a crosswalk, based on the image, motion acquisition means for acquiring a change in a motion vector of the pedestrian and a facial state of the pedestrian, estimation means for estimating a motion of the pedestrian with respect to the crosswalk, based on the change in the motion vector and the facial state, and output means for outputting information regarding the motion of the pedestrian based on an estimation result.

A driving assistance system according to an aspect of the present disclosure includes a driving assistance device provided in a host vehicle, and a driving assistance device provided in another vehicle traveling in an opposite lane. The driving assistance device provided in the another vehicle includes image acquisition means for acquiring an image obtained by imaging a crosswalk in a travel direction from the another vehicle, pedestrian detection means for detecting a pedestrian present within a predetermined distance from a crosswalk, based on the image, motion acquisition means for acquiring a change in a motion vector of the pedestrian and a facial state of the pedestrian, estimation means for estimating a motion of the pedestrian with respect to the crosswalk, based on the change in the motion vector and the facial state, and output means for outputting information regarding the motion of the pedestrian based on an estimation result to the driving assistance device in the host vehicle. The driving assistance device in the host vehicle notifies a driver of the host vehicle of the information regarding the motion of the pedestrian.

A driving assistance system according to an aspect of the present disclosure includes a driving assistance device provided in a host vehicle, and a video recording device provided near the crosswalk. The video recording device includes image acquisition means for acquiring an image obtained by imaging a crosswalk present within a predetermined distance, pedestrian detection means for detecting a pedestrian present within a predetermined distance from a crosswalk, based on the image, motion acquisition means for acquiring a change in a motion vector of the pedestrian and a facial state of the pedestrian, estimation means for estimating a motion of the pedestrian with respect to the crosswalk, based on the change in the motion vector and the facial state, and output means for outputting information regarding the motion of the pedestrian based on an estimation result to the driving assistance device in the host vehicle. The driving assistance device in the host vehicle notifies a driver of the host vehicle of information regarding the motion of the pedestrian.

A driving assistance method according to an aspect of the present disclosure includes by using a computer, acquiring an image obtained by imaging a crosswalk in a travel direction from a host vehicle, detecting a pedestrian present within a predetermined distance from a crosswalk, based on the image, acquiring a change in a motion vector of the pedestrian and a facial state of the pedestrian, estimating a motion of the pedestrian with respect to the crosswalk, based on the change in the motion vector and the facial state, and outputting information regarding the motion of the pedestrian based on an estimation result.

A recording medium according to an aspect of the present disclosure that stores a program that causes a computer to perform a process including acquiring an image obtained by imaging a crosswalk in a travel direction from a host vehicle, detecting a pedestrian present within a predetermined distance from a crosswalk, based on the image, acquiring a change in a motion vector of the pedestrian and a facial state of the pedestrian, estimating a motion of the pedestrian with respect to the crosswalk, based on the change in the motion vector and the facial state, and outputting information regarding the motion of the pedestrian based on an estimation result.

### Advantageous Effects of Invention

According to the present disclosure, it is possible to effectively alert a presence of a pedestrian near a crosswalk.

### BRIEF DESCRIPTION OF DRAWINGS

FIG. 1 is a block diagram illustrating a configuration example of a driving assistance device according to a first example embodiment.

FIG. 2 is a diagram illustrating a hardware configuration of the driving assistance device according to the first example embodiment that is implemented by a computer device and some peripheral devices.

FIG. 3 is a diagram for explaining locations of a pedestrian with respect to a crosswalk in the first example embodiment.

FIG. 4 is an example of a screen of information regarding a motion of a pedestrian to be output by an output unit in the first example embodiment.

FIG. 5 is a flowchart illustrating an operation of the driving assistance device according to the first example embodiment.

FIG. 6 is a block diagram illustrating a configuration example of a driving assistance system according to a second example embodiment.

FIG. 7 is a diagram for explaining a location of a pedestrian near a crosswalk in the second example embodiment.

FIG. 8 is a flowchart illustrating an operation of a driving assistance system according to a second example embodiment.

### EXAMPLE EMBODIMENT

A detailed description will be given below, with reference to the accompanying drawings, of some example embodiments of a driving assistance device, a driving assistance system, a driving assistance method, and a non-transitory recording medium recording a program, according to the present disclosure. The present example embodiments are not intended to limit the disclosed technology.

### First Example Embodiment

A driving assistance system 10 according to a present modification includes a driving assistance device 100 and a display device 200. Examples of the display device 200 include a terminal device possessed by a pedestrian and signage and a road sign provided on a road.

The driving assistance device 100 according to a present example embodiment performs a process of detecting a pedestrian near a crosswalk, based on image information acquired from a video recorder in a host vehicle being driven by a driver or a video recording device, such as a traffic light, provided on a road. In the present example embodiment, in particular, a pedestrian who can possibly traverse a crosswalk is detected in a travel direction of the host vehicle.

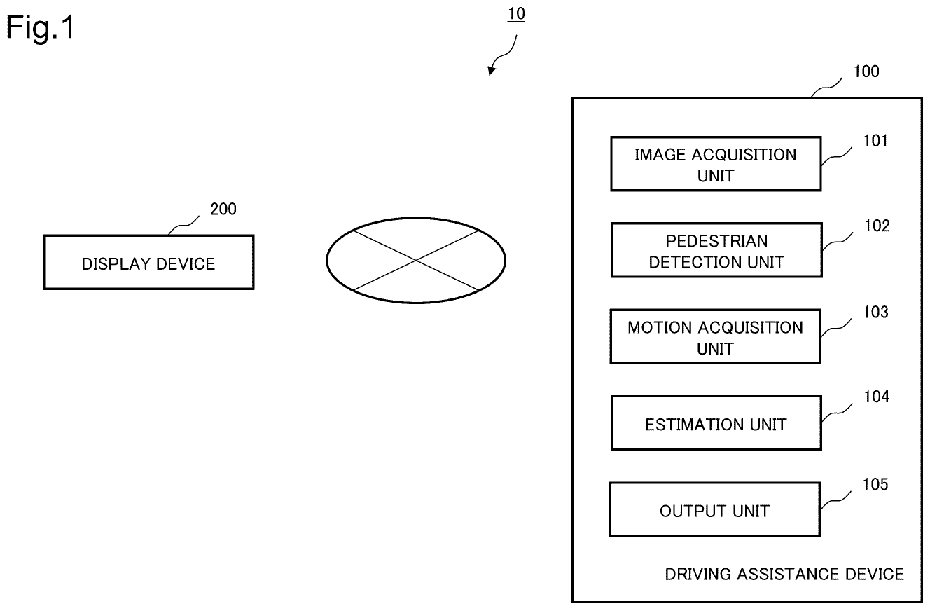

FIG. 1 is a block diagram illustrating a configuration example of an information provision system according to a first example embodiment.

Referring to FIG. 1, the driving assistance device 100 includes an image acquisition unit 101, a pedestrian detection unit 102, a motion acquisition unit 103, an estimation unit 104, and an output unit 105.

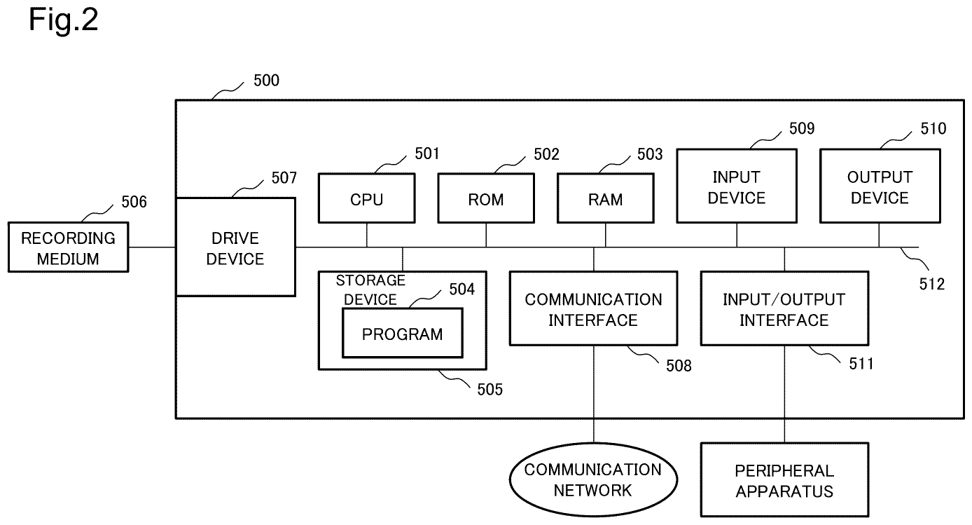

FIG. 2 is a diagram illustrating an example of a hardware configuration of the driving assistance device 100 according to the first example embodiment of the present disclosure that is achieved by a computer device 500 including a processor. As illustrated in FIG. 2, the driving assistance device 100 includes: a central processing unit (CPU) 501; memories, such as a read only memory (ROM) 502 and a random access memory (RAM) 503; a storage device 505, such as a hard disk, that stores a program 504; a communication interface 508 for network connection; and an input/output interface 509 via which data is to be inputted or outputted. In the first example embodiment, the driving assistance device 100 is connected to a plurality of components via a bus 510. Alternatively, the driving assistance device 100 according to the first example embodiment illustrated in FIG. 1 can also be constituted by cloud computing, for example.

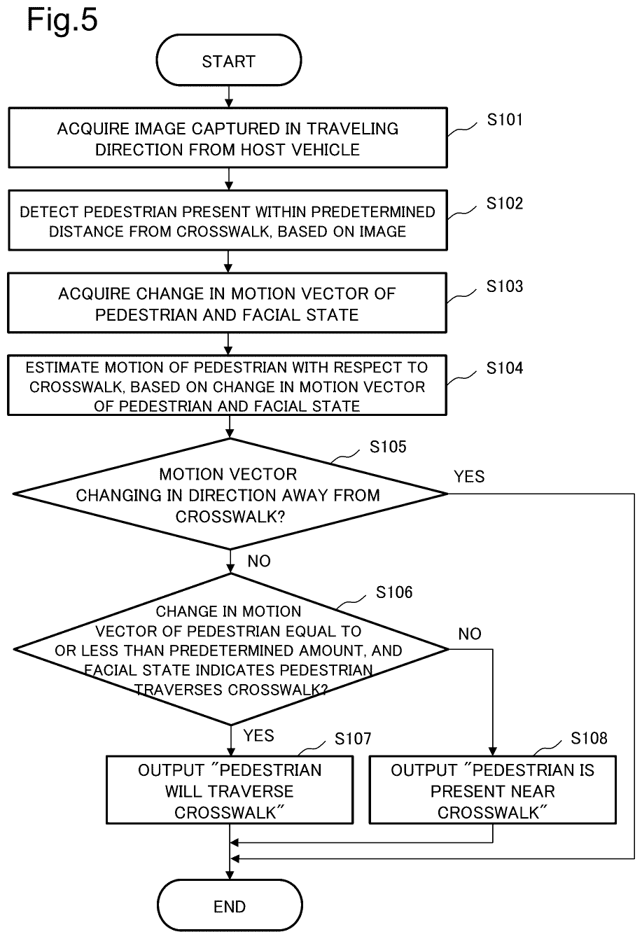

The CPU 501 activates an operating system to control the entire driving assistance device 100 according to the first example embodiment of the present invention. In addition, the CPU 501 reads programs and data from a recording medium 506 mounted in, for example, a drive device 507 or other device onto a memory. Furthermore, the CPU 501 functions as the image acquisition unit 101, the pedestrian detection unit 102, the motion acquisition unit 103, the estimation unit 104, the output unit 105, and some of these in the first example embodiment and executes a process or commands in a flowchart illustrated in FIG. 5, which will be described later based on a program.

Examples of the recording medium 506 include an optical disc, a flexible disk, a magnetic optical disc, an external hard disk, and a semiconductor memory. A semiconductor memory or other memory, which is one of recording media, is a non-volatile storage device and records programs therein. The programs may be downloaded from an external computer (not illustrated) connected to a communication network.

As described above, the first example embodiment illustrated in FIG. 1 is implemented by the computer hardware illustrated in FIG. 2. However, means for implementing a plurality of units included in the driving assistance device 100 in FIG. 1 is not limited to the above-described configuration. The driving assistance device 100 may be implemented by a single physically coupled device or may be implemented by a system constituted by connecting two or more physically separated devices in a wired or wireless manner. The driving assistance device 100 is formed as a system implemented by a device in which the driving assistance device 100 and the display device are separated.

The image acquisition unit 101 is means for acquiring a photographic image obtained by imaging a travel direction from a host vehicle. For example, the image acquisition unit 101 acquires image data of a moving image captured by a front camera in the host vehicle. The image acquisition unit 101 outputs the acquired image data to the pedestrian detection unit 102.

The pedestrian detection unit 102 is means for detecting a pedestrian present within a predetermined distance from a crosswalk, based on the image. The pedestrian detection unit 102 analyzes the image data captured by the image acquisition unit 101, detects the crosswalk, and determines whether the pedestrian is present within a predetermined distance (e.g., within 3 m) from the crosswalk. The distance from the crosswalk may be a distance from a nearer one of the sides of the crosswalk or a distance from the center of the crosswalk. A method by which the pedestrian detection unit 102 detects a pedestrian within a predetermined distance from a crosswalk may be a method using an existing technique.

The motion acquisition unit 103 is means for acquiring a change in a motion vector of the pedestrian and facial states of the pedestrian. The motion vector refers to a magnitude of a change in a location and an orientation of the pedestrian over a predetermined time. Specifically, for example, the motion acquisition unit 103 calculates a magnitude of a change in a location and an orientation of the pedestrian over a predetermined time by determining the magnitude of the position change and the orientation of the pedestrian using the image data of the moving image and then dividing them by a capturing time interval.

The motion acquisition unit 103 extracts the facial states of the pedestrian' from the captured image data. The facial states of the pedestrian in the present example embodiment include: the orientation, such as the front, back (back of the head), or side (side face), of the pedestrian's face as viewed from the host vehicle; a motion of a portion of the face above the neck, such as looking at the left and right; the line of sight of the pedestrian; a motion of the pedestrian's mouth; a state of a complexion due to drinking or poor physical condition; and a wearing state of a voice output device, such as an earphone or a headphone. Furthermore, the motion acquisition unit 103 may estimate these facial states, based on the photographic image data.

The estimation unit 104 estimates a motion of the pedestrian with respect to the crosswalk, based on the change in the motion vector of the pedestrian and the facial states. Specifically, the estimation unit 104 estimates whether the pedestrian is about to traverse the crosswalk, depending on whether the change in the motion vector of the pedestrian is equal to or less than a predetermined amount.

The estimation unit 104 analyzes whether the facial state indicates that the pedestrian is about to traverse the crosswalk, thereby estimating the motion of the pedestrian. For example, the estimation unit 104 extracts, in advance, a feature amount from a sample image of a pedestrian who is about to traverse a crosswalk and then estimates whether the pedestrian is about to traverse the crosswalk, based on the extracted feature amount.

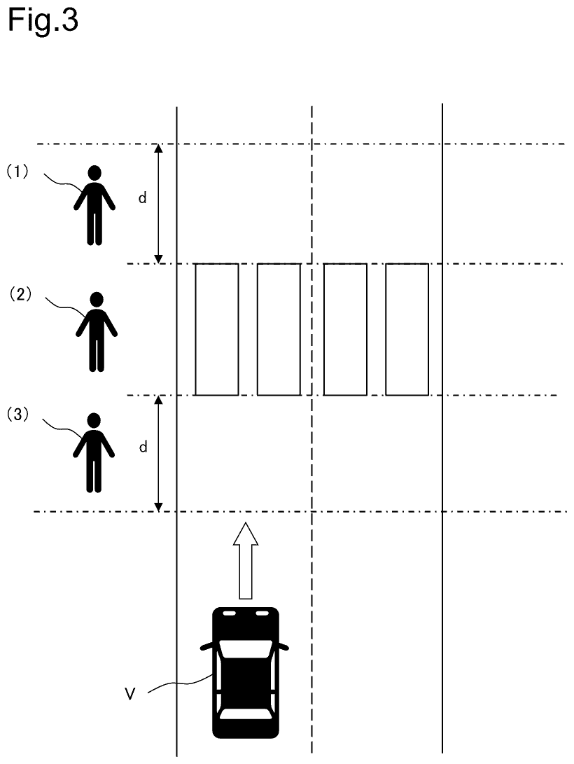

A description will be given, by using the drawing, of a specific method by which the estimation unit 104 estimates a motion of a pedestrian with respect to a crosswalk. FIG. 3 is a diagram for explaining locations of a pedestrian with respect to a crosswalk in the present example embodiment. As illustrated in FIG. 3, the possible cases are (1) a case where a pedestrian is on a farther one of the sides of a crosswalk as viewed from a host vehicle, (2) a case where a pedestrian is just beside the crosswalk, and (3) a case where a pedestrian is on a nearer one of the sides of the crosswalk as viewed from the host vehicle. In FIG. 3, d denotes an example indicating a predetermined distance.

When the change in the motion vector of the pedestrian is equal to or less than a predetermined amount and the facial state indicates that the pedestrian is about to traverse the crosswalk in (1) (2), or (3), the estimation unit 104 estimates that there is a possibility of traversing the crosswalk. Examples of the facial states indicating that the pedestrian is about to traverse the crosswalk include a state where the face is oriented to the crosswalk and a state where the pedestrian is oriented to the crosswalk with the face moving in the right and left directions. However, the facial state of the pedestrian detected by the estimation unit 104 is not limited thereto and may be any state from which it can be estimated that the pedestrian is about to traverse the crosswalk.

When the motion vector of the pedestrian is moving in a direction away from the crosswalk, the estimation unit 104 estimates that there is no possibility of traversing the crosswalk. In other words, when the direction of the motion vector of the pedestrian changes to a direction different from the direction toward the crosswalk, the estimation unit 104 estimates that there is no possibility of traversing the crosswalk. More specifically, when the orientation of the face is oriented to the back of the head as viewed from the driver of the host vehicle and the pedestrian is moving in a direction away from the host vehicle in (1), the estimation unit 104 estimates that the pedestrian will not traverse the crosswalk. When the orientation of the face is oriented to the front (face side) as viewed from the driver of the host vehicle and the pedestrian is moving in a direction toward the host vehicle in (3), the estimation unit 104 estimates that the pedestrian will not traverse the crosswalk.

When the amount of the change in the motion vector is larger than a predetermined amount, the estimation unit 104 does not estimate whether the pedestrian will traverse the crosswalk. For example, when the pedestrian is moving in a direction toward the crosswalk by a predetermined amount or more in (1) or (3), the estimation unit 104 does not estimate whether the pedestrian will traverse the crosswalk. When the amount of the change in the motion vector is equal to or less than a predetermined amount but nevertheless the facial states do not indicate that the pedestrian is about to traverse the crosswalk, the estimation unit 104 does not estimate whether the pedestrian will traverse the crosswalk. For example, when the estimation unit 104 estimates that the pedestrian is talking with someone, based on the motion of the mouth acquired by the motion acquisition unit 103 and the facial state does not indicate that the pedestrian is about to traverse the crosswalk, the estimation unit 104 does not estimate whether the pedestrian will traverse the crosswalk. Furthermore, when the estimation unit 104 estimates that the pedestrian is looking at a terminal device possessed by the pedestrian, based on the line of sight of a user acquired by the motion acquisition unit 103 and the facial states do not indicate that the pedestrian is about to traverse the crosswalk, the estimation unit 104 does not estimate whether the pedestrian will traverse the crosswalk. This is because it is not possible to estimate whether the pedestrian will traverse the crosswalk in such cases.

The output unit 105 is means for outputting information regarding the motion of the pedestrian based on the estimation result. The output unit 105 alarms the driver in such a way that a notification level becomes higher when the estimation unit 104 has estimated that there is a possibility that the pedestrian will traverse the crosswalk than when the estimation unit 104 has not estimated whether the pedestrian will traverse the crosswalk. Herein, the higher the notification level, the higher the degree of warning. The output unit 105 may alarm the driver by tightening a seat belt. In this case, the output unit 105 controls the degree of tightening of the seat belt in such a way as to become higher when the estimation unit 104 has estimated that there is a possibility that the pedestrian will traverse the crosswalk than when the estimation unit 104 has not estimated whether the pedestrian will traverse the crosswalk.

The output unit 105 may notify the information regarding the motion of the pedestrian by emitting a voice sound via a speaker in the host vehicle or may make the notification using text or an image on a screen of a display device, such as a meter panel or a car navigation system, in the host vehicle. In this case, when the estimation unit 104 has estimated that there is a possibility that the pedestrian will traverse the crosswalk, the output unit 105 notifies the driver of the host vehicle that the pedestrian will traverse the crosswalk. The output unit 105 may notify the vehicle to decelerate in front of the crosswalk. When the estimation unit 104 has not estimated whether the pedestrian will make a traverse, the output unit 105 simply notifies the driver of the host vehicle that a pedestrian is present near the crosswalk.

An output destination for the output unit 105 is not limited to a display device in the host vehicle; as an alternative example, the output destination may be a display device, such as signage or a road sign, provided near the crosswalk. In this case, the output unit 105 transmits the information regarding the motion of the pedestrian to the display device near the crosswalk, in accordance with the vehicle-to-infrastructure (V2I) standard. In addition, the output unit 105 may transmit the information regarding the host vehicle to the pedestrian's terminal device by using the vehicle-to-pedestrian (V2P) standard. In this case, the output unit 105 can alert the pedestrian as well.

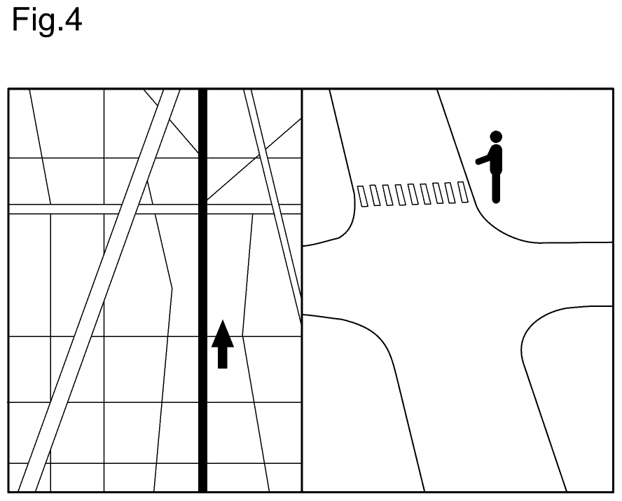

FIG. 4 is an example of a screen of information regarding the motion of the pedestrian to be output by an output unit in the first example embodiment. The example of FIG. 4 is an example in which information regarding the motion of the pedestrian is output to the screen of the car navigation system in the host vehicle. As illustrated in FIG. 4, the car navigation system displays a map indicating a current location of the host vehicle on a left area of the screen and also displays a state of the crosswalk present ahead of the host vehicle in an enlarged manner on a right area of the screen. Furthermore, the car navigation system displays a state of the pedestrian near the crosswalk on the right area of the screen. As illustrated in FIG. 4, the output unit 105 may visually indicate the pedestrian near the crosswalk. In the example of FIG. 4, the output unit 105 indicates a state where the pedestrian is standing and looking at the crosswalk. In FIG. 4, the output unit 105 may also visually indicate the change in the motion vector of the pedestrian and the facial states.

FIG. 5 is a flowchart illustrating a general operation of the driving assistance device 100 according to the first example embodiment. It should be noted that a process according to this flowchart may be performed based on program control executed by the processor described above. The process according to this flowchart is performed whenever the pedestrian detection unit 102 detects a pedestrian within a predetermined distance from a crosswalk.

FIG. 5 is a flowchart illustrating an operation of the driving assistance device 100 according to the first example embodiment. The image acquisition unit 101 acquires an image obtained by imaging a travel direction from a host vehicle (step S101). Based on the image, the pedestrian detection unit 102 then detects a pedestrian present within a predetermined distance from a crosswalk (step S102). The motion acquisition unit 103 then acquires a change in a motion vector of the pedestrian and facial states of the pedestrian (step S103).

Based on the change in the motion vector of the pedestrian and the facial states, the estimation unit 104 then estimates a motion of the pedestrian with respect to the crosswalk (step S104). When the motion vector is changing in a direction away from the crosswalk (YES at step S105), the estimation unit 104 terminates the process. When the motion vector is not changing in the direction away from the crosswalk (NO at step S105), the estimation unit 104 makes the process proceed to step S106.

When the estimation unit 104 that the change in the motion vector of the pedestrian is equal to or less than a predetermined amount and the facial states indicates that the pedestrian is about to traverse the crosswalk (YES at step S106), the output unit 105 outputs that the pedestrian will traverse the crosswalk (step S107). When the estimation unit 104 that the change in the motion vector of the pedestrian is equal to or less than the predetermined amount and the facial states do not indicate that the pedestrian is about to traverse the crosswalk (NO at step S106), the output unit 105 outputs that the pedestrian is present near the crosswalk (step S108). After the above, the driving assistance device 100 terminates the process.

In a driving assistance device 100 according to the first example embodiment, as described above, an estimation unit 104 estimates a motion of a pedestrian with respect to a crosswalk, based on a change in a motion vector of the pedestrian and facial states of the pedestrian, and the output unit 105 outputs information regarding the motion of the pedestrian based on an estimation result. In this case, when there is a possibility that the pedestrian will traverse the crosswalk, for example, the driving assistance device 100 can strongly alert the driver by notifying the driver of contents that call for more attention. Consequently, it is possible to effectively alert the presence of the pedestrian near the crosswalk.

### Modification of First Example Embodiment

Next, a description will be given of a modification of the first example embodiment of the present disclosure. Hereinafter, the description of content overlapping with the above description will be omitted to the extent that description of the present modification is not unclear.

In the present modification, an estimation unit 104 further estimates an awareness state of a host vehicle, based on a change in a motion vector and facial states. When a pedestrian near a crosswalk is not looking in a direction of a host vehicle or when he/she is distracted by other things, for example, the pedestrian is less likely to have been aware of presence of the host vehicle. When a pedestrian near the crosswalk is looking in the direction of the host vehicle, there is a high possibility that the pedestrian is aware of the presence of the host vehicle.

The estimation unit 104, first, estimates whether the pedestrian is approaching the crosswalk, based on the change in the motion vector. When the pedestrian is approaching the crosswalk, the estimation unit 104 estimates whether there is a possibility that the pedestrian is aware of presence of the host vehicle, based on an orientation of the pedestrian's face. In other words, when the pedestrian's face is oriented to a terminal device possessed by him/her and is not oriented in a direction toward the crosswalk or the host vehicle, the estimation unit 104 estimates that there is a possibility that the pedestrian has not been aware of the presence of the host vehicle. In response to this, an output unit 105 increases a notification level and outputs information regarding a motion of the pedestrian. When the pedestrian's face is oriented in the direction toward the crosswalk or the host vehicle, the estimation unit 104 estimates that there is a possibility that the pedestrian is aware of the presence of the host vehicle. In response to this, the output unit 105 outputs information regarding the motion of the pedestrian without increasing the notification level.

As another example, the estimation unit 104 may estimate whether there is a possibility that the pedestrian is aware of the presence of the host vehicle, based on facial states other than the orientation of the face. In this case, when a pedestrian has a ruddy complexion due to drinking or when a pedestrian wears an earphone, for example, the estimation unit 104 may also estimate that there is a possibility that the pedestrian has not been aware of the presence of the host vehicle. In response to this, an output unit 105 increases a notification level and outputs information regarding a motion of the pedestrian. In the present modification, a specific example of a method by which the output unit 105 varies the notification level is the same as the method in the first example embodiment, and the output unit 105 may increase the notification level to any given level. In the first embodiment, for example, even when the estimation unit 104 has not estimated whether the pedestrian will traverse the crosswalk, the output unit 105 may output the information regarding the motion of the pedestrian at the same notification level as when the estimation unit 104 has estimated that there is a possibility that the pedestrian will traverse the crosswalk.

In the present modification, when the estimation unit 104 has estimated that there is a possibility that the pedestrian has not been aware of the presence of the host vehicle, the output unit 105 may also transmit information regarding the presence of the host vehicle to a pedestrian's terminal device. When receiving the information regarding the presence of the host vehicle, the terminal device may transmit positional information of a GPS, for example, in the terminal device to the driving assistance device 100. Furthermore, the output unit 105 in the driving assistance device 100 may display the position information of the terminal device on a map or a navigation screen. In this case, the output unit 105 can display accurate positional information of the pedestrian to the driver.

In a driving assistance device 100 according to the modification of the first example embodiment, as described above, an estimation unit 104 estimates an awareness state of a host vehicle, based on a change in a motion vector and facial states. An output unit 105 then varies a notification level, depending on the awareness state of the host vehicle and outputs information regarding a motion of a pedestrian.

Consequently, when an even stronger alert is necessary, it is possible to notify a driver of information on the pedestrian at a higher notification level.

### Second Example Embodiment

Next, a second example embodiment of the present disclosure will be described in detail with reference to the drawings. Hereinafter, description of the content overlapping with the above description will be omitted to the extent that the description of the present example embodiment is not unclear.

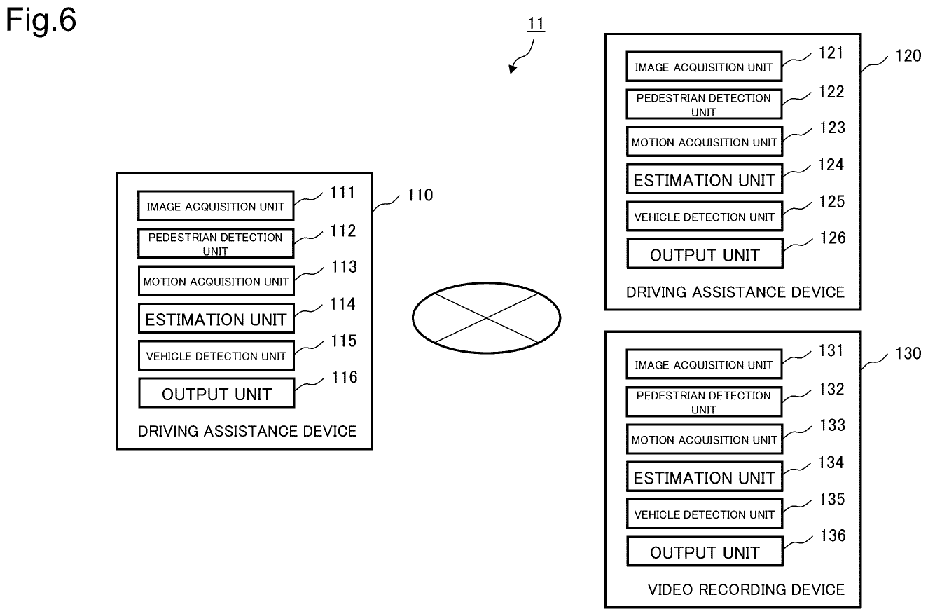

FIG. 6 is a block diagram illustrating a configuration example of a driving assistance system 11 according to the second example embodiment. The driving assistance system 11 according to the present example embodiment includes: a driving assistance device 110 mounted on a host vehicle, a driving assistance device 120 mounted on another vehicle; and a video recording device 130 installed in a road infrastructure, such as a traffic light, near a crosswalk, all of which are interconnected via a communication network.

Communication between these devices, such as inter-vehicle communication between the host vehicle and the another vehicle, is conducted in accordance with a vehicle-to-vehicle (V2V) standard. Furthermore, communication between each vehicle and the road infrastructure is conducted in accordance with the V2I standard. In the present example embodiment, both of the driving assistance device 120 and the video recording device 130 do not have to be present, and it does not matter if either of the devices may be present.

In the present example embodiment, functions of each of the driving assistance device 110, the driving assistance device 120, and the video recording device 130 can be implemented not only by hardware but also by a computer device based on program control or software, similar to the computing device illustrated in FIG. 2.

An assumption in the present example embodiment is that, when detecting a pedestrian present within a predetermined distance from a crosswalk, based on an image obtained by imaging the crosswalk, each of the driving assistance devices 110 and 120 and the video recording device 130 transmits information on a motion of the pedestrian to other driving assistance devices and other devices. The driving assistance device 110, the driving assistance device 120, and the video recording device 130 include, in addition to the configuration of the driving assistance device 100 in the first example embodiment, vehicle detection units 115, 125, and 135, respectively, that detect a vehicle that the driving assistance device 120, and the video recording device 130 need to notify of information regarding a motion of a pedestrian.

Each of the vehicle detection units 115, 125, and 135 is means for, when detecting a pedestrian present within a predetermined distance from a crosswalk, detecting a vehicle approaching the crosswalk. Each of the vehicle detection units 115 and 125 in the driving assistance devices 110 and 120 analyzes an image obtained by imaging a crosswalk in a travel direction from the host vehicle and detects a vehicle traveling within a predetermined distance in front of the crosswalk. The vehicle detection unit 135 in the video recording device 130 analyzes an image captured from above the crosswalk and detects a vehicle traveling within a predetermined distance in front of the crosswalk. A method by which each of the vehicle detection units 115, 125, and 135 detects a vehicle may use an existing technique. More specifically, each of the vehicle detection unit 115, 125, and 135 detects a vehicle that cannot detect a pedestrian within a blind spot thereof.

In the present example embodiment, output units 116, 126, and 136 each transmit information regarding a motion of the pedestrian to the detected vehicle. In response, the output unit 116 or 126 in the receiving vehicle notifies the driver of this information. A method of notifying the driver is the same as the method in the first example embodiment.

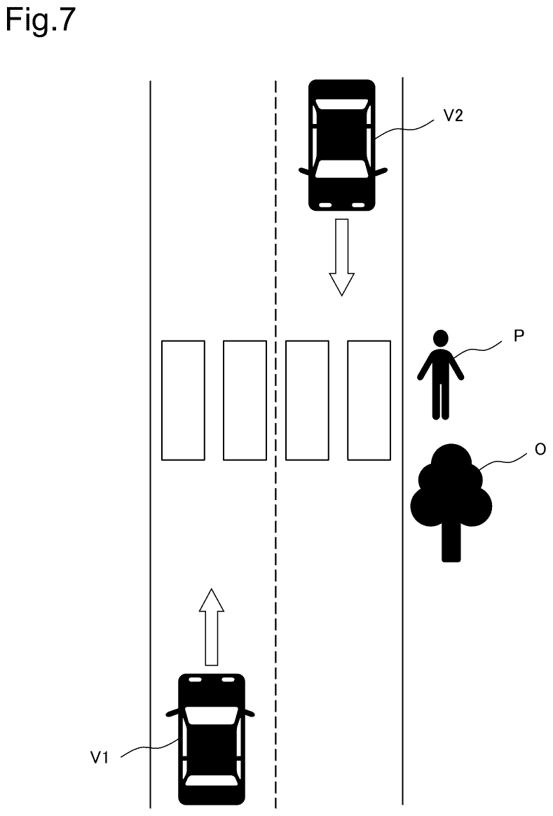

A description will be given of an example case where information regarding a motion of a pedestrian is transmitted between the driving assistance devices 110 and 120, with reference to FIG. 7. FIG. 7 is a diagram for explaining a location of a pedestrian near a crosswalk. In an example of FIG. 7, a host vehicle V1 includes the driving assistance device 110, whereas another vehicle V2 is traveling in a lane opposite to a lane of the host vehicle and includes the driving assistance device 120. As illustrated in FIG. 7, there is a pedestrian P and an obstacle O in front of the pedestrian P on the lane opposite to the lane of the host vehicle V1. In this case, the pedestrian P may fail to be detected from an image captured from the host vehicle V1 because the pedestrian P is within a blind spot of the obstacle O. In this case, the vehicle detection unit 125 in the driving assistance device 120 detects the host vehicle V1, and the output unit 126 transmits information regarding a motion of the pedestrian P to the driving assistance device 110. In response to this, the driving assistance device 110 notifies the driver of the information regarding the motion of the pedestrian P that has been received from the driving assistance device 120 of the another vehicle V2 via the output unit 116. In FIG. 7, an example in which the driving assistance device 120 transmits information regarding a motion of a pedestrian to the driving assistance device 110 has been described; however, the present example embodiment is not limited to this. For example, the video recording device 130 may transmit information regarding a motion of a pedestrian to the driving assistance device 110 or the driving assistance device 120.

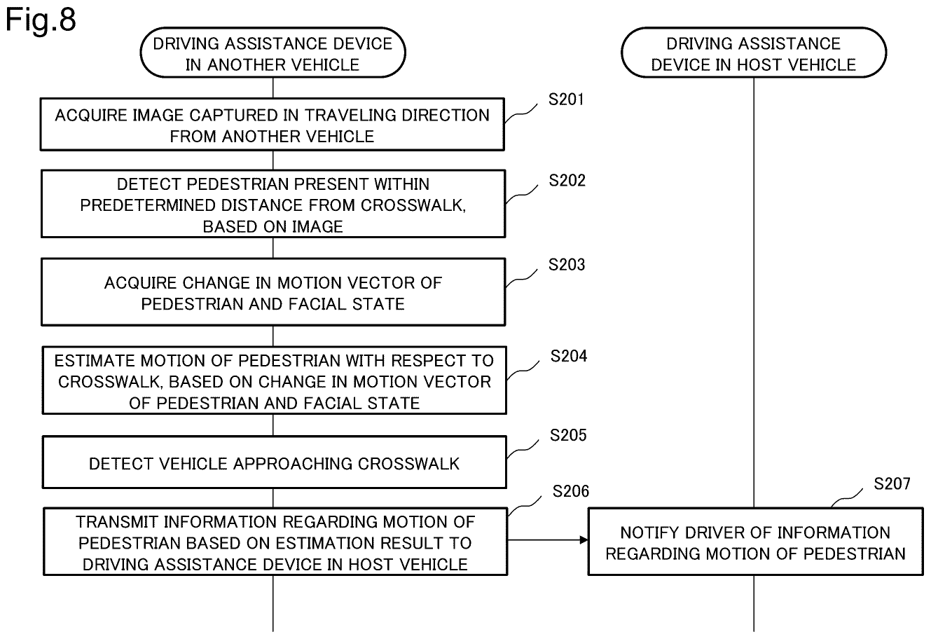

FIG. 8 is a flowchart illustrating an operation of the driving assistance system 11 according to the second example embodiment. It should be noted that a process according to this flowchart may be performed based on program control executed by the processor described above. In this flowchart, an example in which the driving assistance device 120 transmits information regarding a motion of a pedestrian to the driving assistance device 110 will be described; however, the present disclosure is not limited to this.

As illustrated in FIG. 8, the processes at steps S201 to S204 are the same as operations of the driving assistance device 100 in the first example embodiment. More specifically, an image acquisition unit 121 acquires an image obtained by imaging a travel direction from the another vehicle (step S201). Based on the image, a pedestrian detection unit 122 then detects a pedestrian present within a predetermined distance from a crosswalk (step S202). A motion acquisition unit 123 then acquires a change in a motion vector of the pedestrian and facial states of the pedestrian (step S203). Based on the change in the motion vector of the pedestrian and the facial states of the pedestrian, an estimation unit 124 then estimates a motion of the pedestrian with respect to the crosswalk (step S204). The vehicle detection unit 125 then detects a vehicle approaching the crosswalk (step S205). The output unit 126 then transmits information regarding the motion of the pedestrian based on the estimation result to the driving assistance device 110 in the host vehicle (step S206). In response to this, the output unit 116 of the driving assistance device 110 in the host vehicle notifies the driver of the host vehicle of the information regarding the motion of the pedestrian (step S207). After the above, the driving assistance system 11 terminates the process.

In the second example embodiment, as described above, a driving assistance system 11 notifies a driver of a host vehicle of information regarding a motion of a pedestrian detected by a driving assistance device 120 or a video recording device 130 in another vehicle. Consequently, even when a pedestrian is present in a place that is within a blind spot as viewed from the host vehicle, for example, it is possible to recognize information regarding the motion of the pedestrian.

While the present disclosure has been particularly shown and described with reference to each of the example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above-described example embodiments may be described as the following supplementary notes, but are not limited to the following supplementary notes.

### (Supplementary Note 1)

A driving assistance device including:
image acquisition means for acquiring an image obtained by imaging a crosswalk in a travel direction from a host vehicle;
pedestrian detection means for detecting a pedestrian present within a predetermined distance from a crosswalk, based on the image;
motion acquisition means for acquiring a change in a motion vector of the pedestrian and a facial state of the pedestrian;
estimation means for estimating a motion of the pedestrian with respect to the crosswalk, based on the change in the motion vector and the facial state; and
output means for outputting information regarding the motion of the pedestrian based on an estimation result.

### (Supplementary Note 2)

The driving assistance device according to Supplementary Note 1, wherein when the change in the motion vector of the pedestrian is equal to or less than a predetermined amount and the facial state indicates that the pedestrian is about to traverse the crosswalk, the estimation means estimates that there is a possibility of traversing the crosswalk.

### (Supplementary Note 3)

The driving assistance device according to Supplementary Note 1 or 2, wherein when the motion vector of the pedestrian changes in a direction away from the crosswalk, the estimation means estimates that there is no possibility of traversing the crosswalk.

### (Supplementary Note 4)

The driving assistance device according to one of Supplementary Notes 1 to 3, wherein when the change in the motion vector of the pedestrian is larger than a predetermined amount or when an amount of the change in the motion vector is equal to or less than the predetermined amount and the facial state does not indicate that the pedestrian is about to traverse a crosswalk, the estimation means does not estimate whether the pedestrian traverses the crosswalk.

### (Supplementary Note 5)

The driving assistance device according to Supplementary Note 4, wherein the output means outputs information that calls for attention to the motion of the pedestrian to a driver of the host vehicle in such a way that a notification level becomes higher when the estimation unit has estimated that there is a probability that the pedestrian traverses the crosswalk than when the estimation unit has not estimated whether the pedestrian traverses the crosswalk.

### (Supplementary Note 6)

The driving assistance device according to Supplementary Note 4, wherein when it is estimated that there is a possibility that the pedestrian travers the crosswalk, the output means outputs that the pedestrian traverses the crosswalk, and when whether the pedestrian traverses the crosswalk is not estimated, the output means outputs that the pedestrian is present near the crosswalk.

### (Supplementary Note 7)

The driving assistance device according to one of Supplementary Notes 1 to 6, wherein the output means outputs the information regarding the motion of the pedestrian to display devices including signage and a road sign provided near the crosswalk.

### (Supplementary Note 8)

The driving assistance device according to one of Supplementary Notes 1 to 7, wherein the output means outputs information regarding presence of the host vehicle to a terminal device possessed by the pedestrian.

### (Supplementary Note 9)

The driving assistance device according to one of Supplementary Notes 1 to 8, wherein
the estimation means estimates an awareness state of the host vehicle, based on the change in the motion vector and the facial state, and
the output means varies a notification level, depending on the awareness state and outputs the information regarding the motion of the pedestrian.

### (Supplementary Note 10)

The driving assistance device according to one of Supplementary Notes 1 to 9, further including
vehicle detection means for detecting a vehicle approaching the crosswalk when the pedestrian detection means detects the pedestrian present within the predetermined distance from the crosswalk, wherein
the output means outputs the information regarding the motion of the pedestrian to the vehicle.

### (Supplementary Note 11)

A driving assistance system including:
a driving assistance device provided in a host vehicle; and a driving assistance device provided in another vehicle traveling in an opposite lane,
the driving assistance device provided in the another vehicle including
image acquisition means for acquiring an image obtained by imaging a crosswalk in a travel direction from the another vehicle,
pedestrian detection means for detecting a pedestrian present within a predetermined distance from a crosswalk, based on the image,
motion acquisition means for acquiring a change in a motion vector of the pedestrian and a facial state of the pedestrian,
estimation means for estimating a motion of the pedestrian with respect to the crosswalk, based on the change in the motion vector and the facial state, and
output means for outputting information regarding the motion of the pedestrian based on an estimation result to the driving assistance device in the host vehicle, wherein
the driving assistance device in the host vehicle notifies a driver of the host vehicle of the information regarding the motion of the pedestrian.

### (Supplementary Note 12)

A driving assistance system including:
a driving assistance device provided in a host vehicle; and a video recording device provided near the crosswalk,
the video recording device including
image acquisition means for acquiring an image obtained by imaging a crosswalk present within a predetermined distance,
pedestrian detection means for detecting a pedestrian present within a predetermined distance from the crosswalk, based on the image,
motion acquisition means for acquiring a change in a motion vector of the pedestrian and a facial state of the pedestrian,
estimation means for estimating a motion of the pedestrian with respect to the crosswalk, based on the change in the motion vector and the facial state, and
output means for outputting information regarding the motion of the pedestrian based on an estimation result to the driving assistance device in the host vehicle,
wherein the driving assistance device in the host vehicle notifies a driver of the host vehicle of information regarding the motion of the pedestrian.

### (Supplementary Note 13)

A driving assistance method including:
by using a computer,
acquiring an image obtained by imaging a crosswalk in a travel direction from a host vehicle;
detecting a pedestrian present within a predetermined distance from a crosswalk, based on the image;
acquiring a change in a motion vector of the pedestrian and a facial state of the pedestrian;
estimating a motion of the pedestrian with respect to the crosswalk, based on the change in the motion vector and the facial state; and
outputting information regarding the motion of the pedestrian based on an estimation result.

### (Supplementary Note 14)

A recording medium storing a program that causes a computer to perform a process including:
acquiring an image obtained by imaging a crosswalk in a travel direction from a host vehicle;
detecting a pedestrian present within a predetermined distance from a crosswalk, based on the image;
acquiring a change in a motion vector of the pedestrian and a facial state of the pedestrian;
estimating a motion of the pedestrian with respect to the crosswalk, based on the change in the motion vector and the facial state; and
outputting information regarding the motion of the pedestrian based on an estimation result.

### REFERENCE SIGNS LIST

10, 11 Driving assistance system
100, 110, 120 Driving assistance device
130 Video recording device
101, 111, 121, 131 Image acquisition unit
102, 112, 122, 132 Pedestrian detection unit
103, 113, 123, 133 Motion acquisition unit
104, 114, 124, 134 Estimation unit
105, 116, 126, 136 Output unit
115, 125, 135 Vehicle detection unit
200 Display device
500 Computer device
501 CPU
502 ROM
503 RAM
504 Program
505 Storage device
506 Recording medium
507 Drive device
508 Communication interface
509 Input/output interface
510 Bus

What is claimed is:

1. A driving assistance device comprising:
at least one memory storing instructions; and
at least one processor configured to execute the instructions to:
acquire an image obtained by imaging a crosswalk in a travel direction from a host vehicle;
detect a pedestrian present within a predetermined distance from the crosswalk, based on the image;
acquire a change in a motion vector of the pedestrian and a facial state of the pedestrian;
estimate a motion of the pedestrian with respect to the crosswalk, based on the change in the motion vector and the facial state; and
output information regarding the motion of the pedestrian based on an estimation result.

2. The driving assistance device according to claim 1, wherein the at least one processor is further configured to execute the instructions to:
in a case where the change in the motion vector of the pedestrian is equal to or less than a predetermined amount and the facial state indicates that the pedestrian is about to traverse the crosswalk, estimate that there is a possibility of the pedestrian traversing the crosswalk.

3. The driving assistance device according to claim 1, wherein the at least one processor is further configured to execute the instructions to:
when the motion vector of the pedestrian changes in a direction away from the crosswalk, estimate that there is no possibility of the pedestrian traversing the crosswalk.

4. The driving assistance device according to claim 1, wherein the at least one processor is further configured to execute the instructions to:
stop estimation of whether the pedestrian traverses the crosswalk in either of cases where
the change in the motion vector of the pedestrian is larger than a predetermined amount; or
where an amount of the change in the motion vector is equal to or less than the predetermined amount and the facial state does not indicate that the pedestrian is about to traverse a crosswalk.

5. The driving assistance device according to claim 4, wherein the at least one processor is further configured to execute the instructions to:
output information that calls for attention to the motion of the pedestrian to a driver of the host vehicle in such a way that a notification level becomes higher when a probability that the pedestrian traverses the crosswalk is estimated than when whether the pedestrian traverses the crosswalk is not estimated.

6. The driving assistance device according to claim 4, wherein the at least one processor is further configured to execute the instructions to:
when a possibility that the pedestrian travers the crosswalk is estimated, output information indicating that the pedestrian traverses the crosswalk, and
when whether the pedestrian traverses the crosswalk is not estimated, output information indicating that the pedestrian is present near the crosswalk.

7. The driving assistance device according to claim 1, wherein the at least one processor is further configured to execute the instructions to:
output the information regarding the motion of the pedestrian to display devices including signage and a road sign provided near the crosswalk.

8. The driving assistance device according to claim 1, wherein the at least one processor is further configured to execute the instructions to:
output information regarding presence of the host vehicle to a terminal device possessed by the pedestrian.

9. The driving assistance device according to claim 1, wherein the at least one processor is further configured to execute the instructions to:
estimate an awareness state of the host vehicle, based on the change in the motion vector and the facial state, and
change a notification level, depending on the awareness state and outputs the information regarding the motion of the pedestrian.

10. The driving assistance device according to claim 1, wherein the at least one processor is further configured to execute the instructions to:
detect a vehicle approaching the crosswalk when the pedestrian present within the predetermined distance from the crosswalk is detected; and
output the information regarding the motion of the pedestrian to the vehicle.

11. A driving assistance device according to claim 1, wherein the at least one processor is further configured to execute the instructions to:
receive information regarding the motion of the pedestrian based on an estimation result output by another driving assistance device provided in another vehicle traveling in an opposite lane; and
notify a driver of the host vehicle of the received information regarding the motion of the pedestrian.

12. A driving assistance device according to claim 1, wherein the at least one processor is further configured to execute the instructions to:
receive information regarding the motion of the pedestrian based on an estimation result output by a video recording device provided near the crosswalk; and
notify a driver of the host vehicle of the received information regarding the motion of the pedestrian, wherein
the video recording device including at least one processor configured to execute the instructions to:
acquire an image obtained by imaging a crosswalk present within a predetermined distance,
detect a pedestrian present within a predetermined distance from the crosswalk, based on the image,
acquire a change in a motion vector of the pedestrian and a facial state of the pedestrian,
estimate a motion of the pedestrian with respect to the crosswalk, based on the change in the motion vector and the facial state, and
output information regarding the motion of the pedestrian based on an estimation result to the driving assistance device in the host vehicle.

13. A driving assistance method comprising:
by using a computer,
acquiring an image obtained by imaging a crosswalk in a travel direction from a host vehicle;
detecting a pedestrian present within a predetermined distance from the crosswalk, based on the image;
acquiring a change in a motion vector of the pedestrian and a facial state of the pedestrian;
estimating a motion of the pedestrian with respect to the crosswalk, based on the change in the motion vector and the facial state; and
outputting information regarding the motion of the pedestrian based on an estimation result.

14. A non-transitory recording medium storing a program that causes a computer to perform a process comprising:
acquiring an image obtained by imaging a crosswalk in a travel direction from a host vehicle;
detecting a pedestrian present within a predetermined distance from the crosswalk, based on the image;
acquiring a change in a motion vector of the pedestrian and a facial state of the pedestrian;
estimating a motion of the pedestrian with respect to the crosswalk, based on the change in the motion vector and the facial state; and
outputting information regarding the motion of the pedestrian based on an estimation result.
